(19) United States
(12) Patent Application Publication
(10) Pub. No.: US 2014/0072716 A1
(43) Pub. Date: Mar. 13, 2014

(54) POLYEPOXIDE-POLYACID COATING COMPOSITIONS, RELATED COATING PROCESSES AND COATED SUBSTRATES

(71) Applicants: Mark E. Endlish, Chicora, PA (US); David Fenn, Allison Park, PA (US); Kevin C. Olson, Wexford, PA (US); Kenneth T. Phelps, New Kensington, PA (US); W. David Polk, Pittsburgh, PA (US)

(72) Inventors: Mark E. Endlish, Chicora, PA (US); David Fenn, Allison Park, PA (US); Kevin C. Olson, Wexford, PA (US); Kenneth T. Phelps, New Kensington, PA (US); W. David Polk, Pittsburgh, PA (US)

(73) Assignee: PPG Industries Ohio, Inc., Cleveland, OH (US)

(21) Appl. No.: 13/613,343

(22) Filed: Sep. 13, 2012

(51) Int. Cl. C09D 133/14; B05D 3/10

(52) U.S. Cl. 427/407.1; 523/400

(57) ABSTRACT

Described are film-forming compositions comprising a polyepoxide and a curing agent comprising an acid functional acrylic polymer, as well as coating systems comprising a coating deposited from such compositions and related processes and coated substrates.

### FIELD

The present invention relates to film-forming compositions comprising a polyepoxide and a curing agent comprising an acid functional acrylic polymer, as well as processes for applying a composite coating to a substrate, and related coated substrates.

### BACKGROUND

Color-plus-clear coating systems involve application of a colored base coat to a substrate and a transparent, often clear, top coat to the base coat. These coating systems are popular as original finishes in a variety of applications, such as, for example, automotive applications, because they can have outstanding gloss and distinctness of image. The clear coat can be particularly important for these properties.

Two-component clearcoat compositions comprising polyisocyanate curing agents and polyols can give outstanding properties. However, the polyisocyanates are difficult to handle because they are sensitive to moisture and require cumbersome safety precautions because of their toxicity.

As an alternative, top coatings employing polyepoxides (such as epoxy-functional acrylics) and polyacid curing agents have been used. In these coatings, the polyacid curing agent is often predominantly an acid functional polyester of high acid functionality, low molecular weight and relatively low solution viscosity. While such polyesters are suitable curing agents in such compositions, the cost to produce them can be higher than desired and they may not exhibit an optimal level of compatibility with epoxy-functional acrylic resins. Furthermore, highly acid functional polyesters of sufficiently low molecular might not be classified as polymers for regulatory purposes. In addition, further improvements to certain coating properties, such as appearance and mar resistance, are desirable.

Acid functional acrylic polymers have also been used as a curing agent in such polyepoxide-polyacid coating compositions, but they have been used as an additive in combination with the acid functional polyester (the predominant curing agent) to provide sag control, rather than as the predominant acid functional curing agent. This has been because of the inability to provide acid functional acrylic polymers of sufficiently low molecular weight, sufficiently low viscosity, and sufficiently high acid functionality to be suitable for use as the predominant, or essentially sole, acid functional curing agent in polyepoxide-polyacid coating compositions, particularly such compositions in which a relatively high resin solids content (>40% by weight or >50% by weight) is desired. Furthermore, it is important that such an acid functional curing agent exhibit low color in addition to the foregoing attributes, if it is going to be employed as the predominant, or essentially sole, acid functional curing agent in a polyepoxide-polyacid composition to be employed as a clear coat composition.

The present invention was made in view of the foregoing.

### SUMMARY OF THE INVENTION

In some respects, the present invention is directed to film-forming compositions. These film-forming compositions comprise (a) a polyepoxide; and (b) a curing agent comprising an acid functional acrylic polymer. The acid functional acrylic polymer comprises a reaction product of an ethylenically unsaturated monomer composition comprising ethylenically unsaturated acid, wherein the polymer has: (i) a weight average molecular weight of 500 to 6000; (ii) a polydispersity value of no more than 2.5; (iii) an acid value of at least 180; and (iv) a Gardner-Holt viscosity of no more than Z2.

In other respects, the present invention is directed to film-forming compositions that comprise (a) an epoxy-containing acrylic polymer; and (b) a curing agent comprising an acid functional acrylic polymer present in an amount of at least 50 percent by weight, based on the total weight of the acid functional components in the composition. The acid functional acrylic polymer comprises a reaction product of an ethylenically unsaturated monomer composition comprising ethylenically unsaturated acid, wherein the polymer has: (i) a weight average molecular weight of 500 to 6000; (ii) a polydispersity value of no more than 2.5; and (iii) an acid value of at least 180. The coating compositions have a resin solids content of greater than 40 percent by weight, based on the total weight of the composition.

The present invention is also directed to, among other things, color plus clear coating systems in which the clear coating is formed from a composition of the present invention, processes for applying a composite coating to a substrate, and related coated substrates.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As indicated earlier, certain embodiments of the present invention are directed to film-forming compositions comprising a polyepoxide.

Among the polyepoxides which can be used are epoxy-containing acrylic polymers, epoxy condensation polymers, such as polyglycidyl ethers of alcohols and phenols, and certain polyepoxide monomers and oligomers.

In certain embodiments, the epoxy-containing acrylic polymer is a copolymer of an ethylenically unsaturated composition comprising: (i) one or more ethylenically unsaturated monomers having at least one epoxy group, and (ii) one or more ethylenically unsaturated monomers which are free of epoxy groups.

Examples of ethylenically unsaturated monomers containing epoxy groups are those containing 1,2-epoxy groups and include glycidyl(meth)acrylate and allyl glycidyl ether. As used herein, “(meth)acrylic” and terms derived therefrom are intended to include both acrylic and methacrylic.

Examples of ethylenically unsaturated monomers which do not contain epoxy groups are alkyl esters of (meth)acrylic acid containing from 1 to 20 atoms in the alkyl group. Suitable alkyl esters of (meth)acrylic acid include methyl(meth)acrylate, ethyl(meth)acrylate, butyl(meth)acrylate, and 2-ethylhexyl(meth)acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The epoxy group-containing ethylenically unsaturated monomer is, in some embodiments, used in an amount of from 5 to 60 percent by weight, such as 20 to 50 percent by weight, based on the total weight of the ethylenically unsaturated composition used to prepare the epoxy-containing acrylic polymer. In certain embodiments, from 40 to 95 percent by weight, such as 50 to 80 percent by weight, of the total weight of the ethylenically unsaturated composition is made up of one or more alkyl esters of (meth)acrylic acid.

In preparing the epoxy-containing acrylic polymer, the epoxide functional monomers and the other ethylenically unsaturated monomers can be mixed and reacted by conventional free radical initiated organic solution polymerization in the presence of suitable catalysts, such as organic peroxides or azo compounds, for example, benzoyl peroxide or N,N′-azobis-(isobutyronitrile). The polymerization can be carried out in an organic solution in which the monomers are soluble. Suitable solvents are aromatic solvents such as xylene and toluene and ketones such as methyl amyl ketone. Alternately, the acrylic polymer may be prepared by aqueous emulsion or dispersion polymerization techniques. In addition, continuous polymerization techniques, such as are described in more detail below with respect to the acid functional acrylic polymer, can be used.

In certain embodiments, the epoxy-containing acrylic polymer has a number average molecular weight of 1,000 to 20,000, such as 1,000 to 10,000, or, in some cases, 1,000 to 5,000. The molecular weight values reported herein can be determined by gel permeation chromatography (GPC) using polystyrene standards as is well known to those skilled in the art and such as is discussed in U.S. Pat. No. 4,739,019, at column 4, lines 2-45.

Suitable epoxy condensation polymers include those having a 1,2-epoxy equivalency greater than 1, such as greater than 1 up to 3.0. Examples of such epoxides are polyglycidyl ethers of polyhydric phenols and of aliphatic alcohols. These polyepoxides can be produced by etherification of the polyhydric phenol or aliphatic alcohol with an epihalohydrin such as epichlorohydrin in the presence of alkali.

Examples of suitable polyphenols are 2,2-bis(4-hydroxyphenyl)propane (bisphenol A), 1,1-bis(4-hydroxyphenyl)ethane and bis(4-hydroxyphenyl)propane. Examples of suitable aliphatic alcohols are ethylene glycol, diethylene glycol, 1,2-propylene glycol and 1,4-butylene glycol. Also, cycloaliphatic polyols, such as 1,2-cyclohexanediol, 1,4-cyclohexanediol, 1,2-bis(hydroxymethyl)cyclohexane and hydrogenated bisphenol A can be used.

Besides the epoxy-containing polymers described above, certain polyepoxide monomers and oligomers can also be used. Examples of these materials are described in U.S. Pat. No. 4,102,942 in column 3, lines 1-16. Specific examples of such low molecular weight polyepoxides are 3,4-epoxycyclohexylmethyl 3,4-epoxycyclohexanecarboxylate and bis(3,4-epoxy-6-methylcyclohexyl-methyl) adipate. These materials are aliphatic polyepoxides as are the epoxy-containing acrylic polymers.

In certain embodiments, the polyepoxide has a glass transition temperature less than 50° C., such as less than 30° C. The glass transition temperature (Tg) is described in PRINCIPLES OF POLYMER CHEMISTRY, Flory, Cornell University Press, Ithaca, N.Y., 1953, pages 52-57 and can be calculated as described by Fox in Bull. Amer. Physic. Soc., 1, 3, page 123 (1956). The Tg can be determined experimentally such as by using a penetrometer such as a DuPont 940 Thermomedian Analyzer. As used herein, “Tg”, when used with reference to the polymers described herein, refers to the calculated values unless otherwise indicated.

In certain embodiments, the polyepoxide is a mixture of epoxy-containing acrylic polymer mentioned above and a lower molecular weight polyepoxide, such as an epoxy condensation polymer mentioned above which has a molecular weight less than 800.

In certain embodiments, the polyepoxide is present in the film-forming compositions of the present invention in an amount of 10 to 90 percent by weight, such as 25 to 75 percent by weight, based on the total weight of resin solids in the composition. When the lower molecular weight polyepoxide is used, it is sometimes used in an amount of 1 to 40 percent by weight, such as 5 to 30 percent by weight, based on the total weight of resin solids in the composition.

As previously mentioned, the film-forming compositions of the present invention comprise a curing agent comprising an acid functional acrylic polymer. The acid functional acrylic polymer comprises a reaction product of an ethylenically unsaturated monomer composition comprising a ethylenically unsaturated acid, such as a monoethylenically unsaturated acid. In certain embodiments, the acid functionality is carboxylic acid, although other acids, such as sulfonic acid, may be used. In certain embodiments, the acid functional acrylic polymer has a Tg of no more than 50° C., such as 0° C. to 50° C., 1° C. to 50° C., 5° C. to 50° C., 10° C. to 50° C., 20° C. to 50° C., 30° C. to 50° C., or 40° C. to 50° C.

In certain embodiments, the acid functional acrylic polymer is a copolymer of an ethylenically unsaturated composition comprising: (i) one or more ethylenically unsaturated monomers having at least one carboxylic acid group, and (ii) one or more ethylenically unsaturated monomers which are free of carboxylic acid groups.

Examples of ethylenically unsaturated monomers having at least one carboxylic acid group, which are suitable for use in preparing the acid functional acrylic polymer used in the compositions of the present invention, include (meth)acrylic acid, maleic acid, fumaric acid, itaconic acid, and partial esters of any of maleic acid, fumaric acid, and itaconic acid. The ethylenically unsaturated monomer(s) having at least one carboxylic acid group is present in an amount sufficient to provide the resulting acrylic polymer with an acid value within the range described below. In certain embodiments, the ethylenically unsaturated monomer(s) having at least one carboxylic acid group are present in an amount of greater than 20 percent by weight, such as at least 25 percent by weight, or, in some cases, at least 30 percent by weight, the weight percent being based on the total weight of the ethylenically unsaturated composition used to make the acrylic polymer. In certain embodiments, the ethylenically unsaturated monomer(s) having at least one carboxylic acid group are present in an amount of no more than 50 percent by weight, such as no more than 40 percent by weight, based on the total weight of the ethylenically unsaturated composition used to make the acrylic polymer.

In certain embodiments, the one or more ethylenically unsaturated monomers which are free of carboxylic acid groups comprises (i) one or more acrylic acid esters; (ii) one or more methacrylic acid esters, and/or (iii) one or more vinyl aromatic monomers.

Examples of acrylic acid esters that are suitable for use in preparing the acid functional acrylic polymer used in the compositions of the present invention include methyl acrylate, ethyl acrylate, propyl acrylate, butyl acrylate, including combinations of two or more thereof. In certain embodiments, such acrylic acid esters have at least 8 carbon atoms in the alkyl group, examples of which include, but are not limited to, 2-ethylhexyl acrylate, lauryl acrylate, isobornyl acrylate, norbornyl acrylate, isononyl acrylate, decyl acrylate, isodecyl acrylate, stearyl acrylate, 3,3,5-trimethylcyclohexylacrylate, and dodecyl acrylate, including combinations of two or more thereof. In certain embodiments, the acrylic acid ester(s), such as acrylic acid ester(s) having at least 8 carbon atoms in the alkyl group, are present in an amount of at least 10 percent by weight, such as at least 15 percent by weight, or, in some cases, at least 20 percent by weight, based on the total weight of the ethylenically unsaturated composition used to make the acrylic polymer. In certain embodiments, the acrylic acid ester(s), such as acrylic acid ester(s) having at least 8 carbon atoms in the alkyl group, are present in an amount of no more than 40 percent by weight, such as no more than 30 percent by weight, based on the total weight of the ethylenically unsaturated composition used to make the acrylic polymer.

Examples of methacrylic acid esters that are suitable for use in preparing the acid functional acrylic polymer used in the compositions of the present invention include, but are not limited to, C₍₁₋₅₎ alkyl esters, such as methyl methacrylate, ethyl methacrylate, propyl methacrylate, butyl methacrylate, including combinations of two or more thereof. In certain embodiments, the methacrylic acid ester(s) are present in an amount of at least 10 percent by weight, such as at least 15 percent by weight, or, in some cases, at least 20 percent by weight, based on the total weight of the ethylenically unsaturated composition used to make the acrylic polymer. In certain embodiments, the methacrylic acid ester(s) are present in an amount of no more than 40 percent by weight, such as no more than 30 percent by weight, based on the total weight of the ethylenically unsaturated composition used to make the acrylic polymer.

Examples of vinyl aromatic monomers that are suitable for use in preparing the acid functional acrylic polymer used in the compositions of the present invention include, but are not limited to, styrene, α-methylstyrene, vinyltoluene, p-methylstyrene, ethylvinylbenzene, vinylnaphthalene, and vinylxylene, including combinations of two or more thereof. In certain embodiments, the vinyl aromatic monomer(s) are present in an amount of at least 1 percent by weight, such as at least 2 percent by weight, or, in some cases, at least 5 percent by weight, based on the total weight of the ethylenically unsaturated composition used to make the acrylic polymer. In certain embodiments, vinyl aromatic monomer(s) are present in an amount of no more than 20 percent by weight, such as no more than 15 percent by weight, based on the total weight of the ethylenically unsaturated composition used to make the acrylic polymer.

In the film-forming compositions of the present invention, the acid functional acrylic polymer has: (i) a weight average molecular weight of 500 to 6000, such as 500 to 5000, such as 1000 to 3000; (ii) a polydispersity value (Mw/Mn) of no more than 2.5, such as no more than 2.2 or no more than 2.0, such as 1.5 to 2.5, 1.5 to 2.2, or, in some cases, 1.5 to 2.0; and (iii) an acid value of at least 180, such as at least 200, at least 220, at least 240, or, in some cases, at least 260. As used herein, “acid value” refers to the theoretical number of milligrams of potassium hydroxide (KOH) required to neutralize the acid functionality of one gram of solid polymer (mg KOH/gram). Those skilled in the art will appreciate that the acid value of a polymer can be calculated based on the amount of acid functional monomer used to make the polymer. The molecular weight values can be determined as described above.

In addition to the foregoing, in certain embodiments, the acid functional acrylic polymer used in the compositions of the present invention also has a Gardner-Holt viscosity of no more than Z2. In some embodiments, the Gardner-Holt viscosity is no more than Z1, no more than Z, no more than Y, or, in some cases, no more than X. Moreover, the Gardner-Holt viscosity is often greater than S, such as at least T, at least U, or, in some cases, at least V or at least W. As used herein, “Gardner-Holt viscosity” refers to the viscosity at 25° C. of a 63% by weight solids solution of the polymer in a solvent solution that is a mixture of 70% by weight n-amyl alcohol (CAS#71-41-0) and 30% by weight SOLVESSO 100 (CAS #63231-51-6). As will be appreciated, a Gardner-Holt viscosity of Z2 corresponds to a viscosity of 36.2 poise, a Gardner-Holt viscosity of Z1 corresponds to a viscosity of 27.0 poise, a Gardner-Holt viscosity of Z corresponds to a viscosity of 22.7 poise, a Gardner-Holt viscosity of Y corresponds to a viscosity of 17.6 poise, a Gardner-Holt viscosity of X corresponds to a viscosity of 12.9 poise, a Gardner-Holt viscosity of W corresponds to a viscosity of 10.7 poise, a Gardner-Holt viscosity of V corresponds to a viscosity of 8.85 poise, a Gardner-Holt viscosity of U corresponds to a viscosity of 6.3 poise, a Gardner-Holt viscosity of T corresponds to a viscosity of 5.5 poise, and a Gardner-Holt viscosity of S corresponds to a viscosity of 5.0 poise.

In addition to the foregoing, in certain embodiments, the acid functional acrylic polymer used in the compositions of the present invention also has low color. In certain embodiments, the acid functional acrylic polymer has an APHA color of no more than 130 or no more than 100, such as 80 or less, such as 70-80, as determined by ASTM D1209.

Suitable methods for making such acid functional acrylic polymers are illustrated in the Examples. In certain embodiments, acid functional acrylic polymers having the foregoing combination of attributes, including the foregoing combination of weight average molecular weight, polydispersity index, acid value, viscosity and color, are made by using a continuous process at high temperature (i.e. greater than 200° C., such as 210 to 250° C., or 230 to 240° C.) and high pressure (i.e. greater than 300 psig, such as 400 to 600 psig) using a relatively low amount of initiator (i.e. less than 10 wt % based on total monomer weight). For example, the temperature can be in a range of 150 to 280° C., such as 160 to 230° C. or 170 to 210° C. In certain embodiments, the polymerization is carried out in the substantial absence of Lewis acids and/or transition metals.

Any suitable free radical polymerization initiator may be used, such as thermal free radical initiators. Suitable thermal free radical initiators include, but are not limited to, peroxide compounds, azo compounds and persulfate compounds. In certain embodiments, the amount of initiator used is 0.01 to 0.5 moles initiator per mole of ethylenically unsaturated composition.

Continuous methods of polymerization are also described in U.S. Pat. No. 7,323,529 at col. 4, line 56 to col. 12, line 65, the cited portion of which being incorporated herein by reference. In certain embodiments, the acid functional acrylic polymer used in the compositions of the present invention is made by a continuous polymerization method employing at least two stirred tank reactors, such as is described in U.S. Pat. No. 7,323,529 at col. 9, lines 22-33. Moreover, in certain embodiments, the contents of the first reactor are maintained at a significantly higher temperature than the contents of the second reactor (such as where the contents of the first reactor are maintained at a temperature of greater than 200° C., such as 210 to 250° C., or 230 to 240° C. and the contents of the second reactor are maintained at a temperature no more than 200° C., such as 150 to 200° C., or 160 to 180° C.). In certain embodiments, greater than 50 percent by weight, such as at least 70 percent by weight or, in some cases, at least 80 percent by weight, of the total initiator to be used for the reaction is used in the first reactor. In addition, in certain embodiments, the residence time of the contents of the first reactor is no more than 20 minutes, such as 1 to 20 minutes or 1 to 10 minutes, whereas, in some embodiments, the residence time of the contents of the second reactor is more than 20 minutes, such as more than 20 minutes to 1 hour, or 30 minutes to 1 hour. “Residence time” is defined in U.S. Pat. No. 7,323,529 at col. 8, lines 54-57.

In certain embodiments, the polymerization is conducted under conditions such that the reaction product contains an amount of residual free monomer of less than 1 percent by weight, such as less than 0.5, or in some cases, less than 0.25 percent by weight, based on the total weight of the monomers used to make the polymer.

It has been discovered that it is possible to produce high solids (as described below) compositions in which the foregoing acid functional acrylic polymer is the predominant or, in some cases, the essentially sole curing agent, in the composition. As a result, in certain embodiments, the foregoing acid functional acrylic polymer is present in the composition in an amount of at least 50 percent by weight, at least 60 percent by weight, at least 70 percent by weight, at least 80 percent by weight, at least 90 percent by weight, or, in some cases, at least 95 percent by weight, the weight percents being based on the total weight of acid functional components in the composition. These compositions, in certain embodiments, can also contain greater than 40 percent by weight, such as greater than 50 percent by weight, or in some cases, greater than 60 percent by weight resin solids, based on the total weight of the composition. The solids content can be determined by heating the composition to 105-110° C. for 1 to 2 hours to drive off the volatile material.

In certain embodiments, the acid functional acrylic polymer described above is not derived from an acid functional acrylic prepolymer. In certain embodiments, the acid functional acrylic polymer described above is not derived from a polysiloxane macromonomer. In certain embodiments, the acid functional acrylic polymer is linear, i.e., it is derived from an ethylenically unsaturated composition comprising less than 5 percent by weight, such as less than 1 percent by weight, or, in some cases, no more than 0.5 percent by weight, of ethylenically unsaturated materials comprising at least two polymerizable unsaturated double bonds.

Besides the foregoing acid group-containing acrylic polymers, the compositions of the present invention may further include other acid group-containing curing agents, such as acid group-containing polyesters formed by reacting a polyol with a polycarboxylic acid or anhydride, ester group-containing oligomers, including half-esters, and monomers containing at least two acid groups, as are described in U.S. Pat. No. 4,681,811 at col. 7, line 47 to col. 9, line 54, the cited portion of which being incorporated herein by reference.

In certain embodiments, the polyacid curing agent(s) is present in the composition in an amount of 10 to 90, such as 25 to 75, or, in some cases, 40 to 60, percent by weight based on total weight of resin solids.

In certain embodiments, the compositions of the present invention also contain an anhydride, such as an anhydride which is a liquid at 25° C. Examples of suitable anhydrides include alkyl-substituted hexahydrophthalic anhydrides wherein the alkyl group contains up to 7 carbons, such as up to 4 carbons, such as methyl hexahydrophthalic anhydride and dodecenyl succinic anhydride. The amount of the anhydride which is used can vary from 0 to 40, such as 2 to 25 percent by weight, based on total weight of resin solids.

The equivalent ratio of carboxyl to epoxy in the film-forming compositions of the present invention is often adjusted so that there are 0.3 to 3.0, such as from 0.8 to 1.5 equivalents of carboxyl(anhydride being considered monofunctional) per equivalent of epoxy.

In certain embodiments, the compositions of the present invention include silane functionality which can be incorporated into the composition by using a reactive silane group-containing material such as gamma-methacryloxypropyltrimethoxysilane or mercaptopropyltrimethoxysilane which can be used in the preparation of the epoxy group-containing acrylic polymer. Such materials coreact with the polymerizing monomers or polymers forming a polymer with silane curing groups. Alternately, a silane group-containing material such as methyltrimethoxysilane can be included in the composition.

In certain embodiments, the compositions of the present invention contain catalysts to accelerate the cure of the epoxy and acid groups. Examples of suitable catalysts are basic materials and include organic amines and quaternary ammonium compounds such as pyridine, piperidine, dimethylaniline, diethylenetriamine, tetramethylammonium chloride, tetramethylammonium acetate, tetramethylbenzylammonium acetate, tetrabutylammonium fluoride, and tetrabutylammonium bromide. The amount of catalyst is often from 0 to 10, such as 0.5 to 3 percent by weight based on resin solids.

Also, optional ingredients such as auxiliary curing agents such as aminoplasts and polyols (including solixane polyols), plasticizers, anti-oxidants, and UV light absorbers can be included in the composition. These ingredients often are present in amounts of up to 5 percent by weight based on resin solids.

In certain embodiments, the compositions of the present invention are organic solvent-borne compositions, which, as used herein, refers to compositions that use one or more volatile organic compounds (“VOC”) as the primary dispersing medium. Thus, in these embodiments, the dispersing medium may consist exclusively of VOC or comprise predominantly, i.e., >50% or more based on the total weight of the dispersing medium, VOC in combination with another material, such as water. Nevertheless, in some embodiments, the compositions of the present invention may be relatively low in VOC content, which, as used herein, means that such compositions comprise no more than 5 pounds of VOC per gallon of the composition. As used herein, “volatile organic compound” or “VOC” refers to compounds that have at least one carbon atom and which are released from the composition during drying and/or curing thereof. Examples of “volatile organic compounds” include, but are not limited to, alcohols, benzenes, toluenes, chloroforms, and cyclohexanes.

In some embodiments, the compositions of the present invention comprise less than 10 percent by weight, such as less than 5 percent by weight, based on the total weight of resin solids, of a half-ester formed from reacting an acid anhydride with a polyol.

In certain embodiments, the compositions of the present invention are employed as a top coat composition, such as a transparent or clear top coat composition, that is applied to a basecoated substrate. After application of the top coat composition to the base coat, the coated substrate is often heated to cure the coating layers. In the curing operation, solvents are driven off and the film-forming material of the top coat and/or of the base coat is crosslinked. The heating or curing operation is often carried out at a temperature in the range of from 160° F. to 350° F. (71° C. to 177° C.) but if needed lower or higher temperatures may be used. The thickness of the top coat is often from 0.5 to 5, such as 1.2 to 3 mils. The film-forming composition of the base coat can be any of the compositions useful in coatings applications, such as automotive applications and comprise a resinous binder and a colorant. Useful resinous binders include, but are not limited to, acrylic polymers, polyesters, including alkyds, and polyurethanes.

The base coat composition may contain metallic flake pigmentation to produce so-called “glamour metallic” finishes. Suitable metallic pigments include in particular aluminum flake, copper bronze flake and mica. The base coat composition may contain non-metallic colorants, including inorganic pigments, such as titanium dioxide, iron oxide, chromium oxide, lead chromate and carbon black, and organic pigments such as phthalocyanine blue and phthalocyanine green. In some cases, non-metallic colorant is incorporated into the coating composition in an amount of 1 to 80 percent by weight, based on weight of coating solids. In some case, the metallic pigment is employed in an amount of 0.5 to 25 percent by weight of the aforesaid aggregate weight.

If desired, the base coat composition may additionally contain other materials well known in the art of formulated surface coatings. These would include surfactants, flow control agents, thixotropic agents, fillers, anti-gassing agents, organic co-solvents, catalysts and other customary auxiliaries. These materials can constitute up to 40 percent by weight of the total weight of the coating composition.

Compositions of the present invention can be applied over virtually any substrate including wood, metals, glass, cloth, plastic, foam, including elastomeric substrates, and the like, and are sometimes applied over metal and/or elastomeric substrates found on motor vehicles.

After application to the substrate of the base coat composition, a film is formed on the surface of the substrate. This is achieved by driving solvent, i.e., organic solvent or water, out of the base coat film by heating or simply by an air-drying period. In certain embodiments, the heating step will only be sufficient and for a short period of time to insure that the top coat composition can be applied to the base coat without the former dissolving the base coat composition, i.e., “striking in”. Suitable drying conditions will depend on the particular base coat composition, on the ambient humidity with certain water-based compositions, but in general a drying time of from 1 to 5 minutes at a temperature of 80° F. to 175° F. (20° C. to 79° C.) will be adequate to insure that mixing of the two coats is minimized. At the same time, the base coat film is adequately wetted by the top coat composition so that satisfactory intercoat adhesion is obtained. Also, more than one base coat and multiple top coats may be applied to develop the optimum appearance. Usually between coats, the previously applied base coat or top coat is flashed, that is, exposed to ambient conditions for 1 to 20 minutes.

Therefore, the present invention is also directed to processes for applying a composite coating to a substrate comprising applying to the substrate a colored film-forming composition to form a base coat and applying to the base coat a top coat film-forming composition to form a transparent top coat over the base coat, wherein the top coat film-forming composition comprises (a) a polyepoxide; and (b) a curing agent comprising an acid functional acrylic polymer of the type described above.

### EXAMPLES

The following examples illustrate exemplary embodiments of the invention. However, the examples are provided for illustrative purposes only, and do not limit the scope of the invention.

### Examples 1-3

### Preparation of Acid Functional Acrylic Polymers

A 300 cm³ electrically heated continuous stirred tank reactor with an internal cooling coil was filled with 2-butoxyethanol and the temperature was adjusted to 235° C. The first reactor charge from Table 1 below was fed to the reactor from a feed tank at 60 cm³/minute, resulting in a residence time of five minutes. The reactor was kept volumetrically full at a pressure of 400-500 psi. The temperature was held constant at 235° C. The reactor output was drained to a waste vessel for the first fifteen minutes and was then diverted to a 3000 cm³ continuous stirred tank reactor fitted with a pressure relief valve set to vent at 35 psi. At this point the second reactor charge was fed to the second reactor at 3.74 cm³/minute. The contents of the second reactor were maintained at 170° C. When 2230 cm³ of product had been added to the second reactor, the outlet valve was opened and the resin was fed to a collection vessel at a rate that maintained a constant fill level, resulting in a 35 minute residence time. The collected resin was diluted to 63% solids with a 70:30 by weight blend of n-amyl alcohol and Solvesso 100 (available from ExxonMobil Chemical Company).

### Example 4

### Preparation of Acid Functional Acrylic Polymer

The procedure of Examples 1-3 was repeated using the reactor charges from Table 1 with the exceptions that the first reactor charge was fed to the first reactor at 20 cm³/minute resulting in a residence time of 15 minutes and the second reactor charge was added to the second reactor at 1.25 cm³/minute. The residence time in the second reactor was 105 minutes.

TABLE 1

| | | Example 1 | Example 2 | Example 3 | Example 4 |
|---|---|---|---|---|---|
| First reactor | Acrylic acid | 1842.5 | 1407.0 | 1340.0 | 1273.3 |
| charge (grams) | 2-ethylhexyl acrylate | 1485.0 | 2793.0 | | 1026.3 |
| | Styrene | 550.0 | | | 380.1 |
| | Methyl methacrylate | 1622.5 | | | 1121.2 |
| | Butyl methacrylate | | | 2660.0 | |
| | di-t-butyl perbenzoate | 330.0 | 252.0 | 240.0 | 228.1 |
| Second reactor | Solvesso 100 | 275.0 | 210.0 | 200.0 | 190.0 |
| charge (grams) | di-t-butyl perbenzoate | 55.0 | 42.0 | 40.0 | 38.0 |
| Monomer | Acrylic acid | 33.5 | 33.5 | 33.5 | 33.5 |
| composition | 2-ethylhexyl acrylate | 27 | 66.5 | | 27 |
| (weight %) | Styrene | 10 | | | 10 |
| | Methyl methacrylate | 29.5 | | | 29.5 |
| | Butyl methacrylate | | | 66.5 | |
| Initiator level (% | First reactor | 6 | 6 | 6 | 6 |
| by weight on | Second reactor | 1 | 1 | 1 | 1 |
| monomers) | | | | | |

The properties of the resins are summarized in Table 2.

TABLE 2

| Resin | Example 1 | Example 2 | Example 3 | Example 4 |
|---|---|---|---|---|
| APHA color* | 75 | 200 | 50 | 125 |
| Total free monomer | 0.19 | 0.13 | 0.90 | 0.11 |
| (weight %) | | | | |
| Mw** | 2083 | 4351 | 1976 | 2306 |
| Mn** | 1127 | 1609 | 1035 | 1086 |
| Polydispersity | 1.8 | 2.7 | 1.9 | 2.1 |
| Acid value*** | 230 | 225 | 244 | 222 |
| Gardner-Holt viscosity | X | W+ | X+ | X− |
| Calculated Tg (° C.) | 45 | −14 | 44 | 45 |

*Determined according to ASTM D1209
**The molecular weight values reported herein were determined by gel permeation chromatography calibrated using linear polystyrene standards.
***mgKOH/g resin solids

### Example 5

### Preparation of Epoxy-Containing Acrylic Polymer

An epoxy-containing acrylic polymer was prepared from the following mixture of ingredients:

| Ingredients | Weight (grams) | Resin Solids |
|---|---|---|
| Charge 1 | | |
| Solvesso 100 | 38.29 | |
| Charge 2 | | |
| Glycidyl methacrylate | 67.86 | 67.86 |
| Butyl methacrylate | 65.76 | 65.76 |
| α-methyl styrene dimer | 2.1 | 2.1 |
| Charge 3 | | |
| Solvesso 100 | 14.93 | |
| t-amyl peroxyacetate | 21.33 | 12.79 |
| Charge 4 | | |
| Glycidyl methacrylate | 12.15 | 12.15 |
| Methyl methacrylate | 0.32 | 0.32 |
| Styrene | 1.12 | 1.12 |
| α-methyl styrene dimer | 0.62 | 0.62 |
| Charge 5 | | |
| Methyl ether propylene glycol acetate | 14.06 | |
| Di-t-amyl peroxide | 0.16 | |
| TOTAL | 239.7 | 162.72 |

Charge 1 was heated to reflux in a suitable reactor fitted to remove water through a Dean-Stark trap. Charges 2 and 3 were added simultaneously with Charge 2 added over 2.5 hours while Charge 3 was added over the course of 4 hours. Charge 4 was added 30 minutes after the completion of Charge 2, and was completed in 30 minutes. Once charge 3 was complete Charge 5 was added in 30 minutes. The reaction mixture was then held at reflux for 2 hours followed by cooling to room temperature. The resultant polymer solution contained 65.8% solids (as measured after 110° C. for 1 hour), had a weight average molecular weight of 2469 and a polydispersity of 2.5 as determined by gel permeation chromatography using polystyrene standards as described above.

### Examples A-C

### Preparation of Transparent Film-Forming Compositions

The following examples (A, B, and C) show the preparation of transparent film-forming compositions prepared with epoxy-containing acrylic polymers and various polyacid curing agents. The coating compositions were evaluated in color-plus-clear applications.

### Example A

A clear film-forming composition was prepared by mixing together the following ingredients.

| | Total Weight | Resin Solids |
|---|---|---|
| Ingredients | (grams) | Weight (grams) |
| Ethyl 3-Ethoxypropionate | 23.55 | — |
| Tinuvin 328¹ | 1.87 | — |
| Tinuvin 123¹ | 0.36 | — |
| Product of Example 5 | 81.13 | 52.82 |
| Polyacid half-ester of di- | 66.45 | 47.18 |
| trimethylolpropane and | | |
| methylhexahydrophthalic anhydride² | | |
| DYNOADDF1³ | 0.1 | — |
| Armeen M2C⁴ | 1.45 | — |
| DISPARLON OX-60⁵ | 0.11 | — |

¹UV absorber or hindered amine light stabilizer available from BASF
²Prepared as in Example F of U.S. Pat. No. 5,256,452A
³Flow additive available from Dynea Oy
⁴Tertiary amine available from AkzoNobel Chemicals
⁵Surface tension modifier available from Kusumoto Chemicals

The composition contained 54.71% by weight resin solids and had a No. 4 Ford cup viscosity of 29.1 seconds

### Example B

A transparent film-forming composition similar was prepared by mixing the following ingredients.

| | Total Weight | Resin Solids |
|---|---|---|
| Ingredients | (grams) | Weight (grams) |
| Ethyl 3-Ethoxypropionate | 45.94 | — |
| Tinuvin 328 | 1.87 | — |
| Tinuvin 123 | 0.36 | — |
| Product of Example 5 | 82.58 | 53.76 |
| Product of Example 4 | 73.4 | 46.24 |
| DYNOADD F1³ | 0.1 | — |
| Armeen M2C⁴ | 1.45 | — |
| DISPARLON OX-60⁵ | 0.11 | — |

The composition contained 50.44% by weight resin solids and had a No. 4 Ford cup viscosity of 28.9 seconds.

### Example C

A transparent film-forming composition similar was prepared by mixing the following ingredients.

| | Total Weight | Resin Solids |
|---|---|---|
| Ingredients | (grams) | Weight (grams) |
| Ethyl 3-Ethoxypropionate | 46.55 | |
| Tinuvin 328 | 1.87 | |
| Tinuvin 123 | 0.36 | |
| Product of Example 5 | 81.9 | 53.31 |
| Product of Example 1 | 72.61 | 46.69 |
| DYNOADD F1³ | 0.1 | |
| Armeen M2C⁴ | 1.45 | |
| DISPARLON OX-60⁵ | 0.11 | |

The composition contained 50.64% by weight resin solids and had a No. 4 Ford cup viscosity of 29.5 seconds.

### Testing

The film-forming compositions of Examples A-C were applied over a black pigmented water-based basecoat available from PPG Industries as BIP2MA475. The basecoats were spray applied, by a siphon feed gun attached to an automatic spraying device, to steel panels at approximately 25° C., 50% relative humidity. The basecoated panels flashed at room temperature for 5 minutes then dehydrated at 70° C. for 7 minutes and had a dry film thickness of 17 microns.

The basecoated panels were allowed to cool to room temperature. Then, Examples A-C were spray applied, by a siphon feed gun attached to an automatic spraying device, to the basecoated steel panels at approximately 25° C., 50% relative humidity. The film-forming compositions were applied in 2 coats wet-on-wet with minimal time between coats. The coated panels were then flashed at room temperature in both horizontal and vertical positions for 10 minutes and then transferred and allowed to bake at 140° C. for 30 minutes while maintaining their flash orientations. The properties of the color-plus-clear panels are reported in the table below.

| | Example | | |
|---|---|---|---|
| | A | B | C |
| Clearcoat film thickness (microns) | 49 | 42 | 42 |
| 20° gloss(horizontal/vertical)¹ | 84/84 | 86/86 | 86/85 |
| DOI (horizontal/vertical)² | 92/88 | 92/89 | 92/86 |
| Fischer microhardness³ | 145 | 105 | 98 |
| 9um mar (% Gloss retention)⁴ | 15 | 51 | 35 |
| Surface appearance Byk Wavescan⁵ | | | |
| Horizontal Longwave | 3.5 | 4.7 | 5.3 |
| Horizontal Shortwave | 22.8 | 25.8 | 24.9 |
| Vertical Longwave | 16.5 | 19.1 | 13.9 |
| Vertical Shortwave | 25.7 | 29.0 | 25.0 |

¹Measured with a Micro-gloss meter available from Byk-Gardner
²Measured on a Tricor DOI-Haze meter model 807A
³Measured on a Fischer HM2000
⁴Determined by the amount of 20° gloss retained after 10 cycles from an Atlas CM-5 Crockmeter fitted with 9 μm abrasive paper from 3M.
⁵Measured on a Byk Wavescan Dual (lower number is better)

Whereas particular embodiments of this invention have been described above for purposes of illustration, it will be evident to those skilled in the art that numerous variations of the details of the present invention may be made without departing from the invention as defined in the appended claims.

What is claimed is:

1. A film-forming composition comprising:
(a) a polyepoxide; and
(b) a curing agent comprising an acid functional acrylic polymer comprising a reaction product of an ethylenically unsaturated monomer composition comprising ethylenically unsaturated acid,
wherein the acid functional acrylic polymer has: (i) a weight average molecular weight of 500 to 6000; (ii) a polydispersity value of no more than 2.5; (iii) an acid value of at least 180; and (iv) a Gardner-Holt viscosity of no more than Z2.

2. The composition of claim 1, wherein the polyepoxide comprises epoxy-containing acrylic polymer.

3. The composition of claim 1, wherein the acid functional acrylic polymer has a Tg of 40° C. to 50° C.

4. The composition of claim 1, wherein the acid functional acrylic polymer is a copolymer of an ethylenically unsaturated composition comprising greater than 20 percent by weight of ethylenically unsaturated monomer having at least one carboxylic acid group, based on the total weight of the ethylenically unsaturated composition used to make the acrylic polymer.

5. The composition of claim 4, wherein the acid functional acrylic polymer is a copolymer of an ethylenically unsaturated composition comprising at least 30 percent by weight of ethylenically unsaturated monomer having at least one carboxylic acid group, based on the total weight of the ethylenically unsaturated composition used to make the acrylic polymer.

6. The composition of claim 4, wherein the acid functional acrylic polymer is a copolymer of an ethylenically unsaturated composition comprising at least 10 percent by weight of an acrylic acid ester have at least 8 carbon atoms in the alkyl group, based on the total weight of the ethylenically unsaturated composition used to make the acrylic polymer.

7. The composition of claim 6, wherein the acid functional acrylic polymer is a copolymer of an ethylenically unsaturated composition comprising at least 10 percent by weight of a methacrylic acid ester containing 1 to 5 carbon atoms in the alkyl group, based on the total weight of the ethylenically unsaturated composition used to make the acrylic polymer.

8. The composition of claim 1, wherein the acid functional acrylic polymer has: (i) a weight average molecular weight of 1000 to 3000; (ii) a polydispersity value of no more than 2.0; and (iii) an acid value of at least 200.

9. The composition of claim 1, wherein the acid functional acrylic polymer has a Gardner-Holt viscosity of greater than S.

10. The composition of claim 1, wherein the acid functional acrylic polymer has an APHA color of no more than 100.

11. The composition of claim 1, wherein the acid functional acrylic polymer is present in the composition in an amount of at least 50 percent by weight, based on the total weight of acid functional components in the composition.

12. The composition of claim 11, wherein the acid functional acrylic polymer is present in the composition in an amount of at least 90 percent by weight, based on the total weight of acid functional components in the composition.

13. The composition of claim 11, wherein the composition comprises greater than 40 percent by weight resin solids, based on the total weight of the composition.

14. A process for applying a composite coating to a substrate comprising:
(a) applying to the substrate a colored film-forming composition to form a base coat; and
(b) applying to the base coat a film-forming composition to form a transparent top coat over the base coat, wherein the film-forming composition comprises the composition of claim 1.

15. A film-forming composition comprising:
(a) an epoxy-containing acrylic polymer; and
(b) a curing agent comprising an acid functional acrylic polymer present in an amount of at least 50 percent by weight, based on the total weight of the curing agent,
wherein the acid functional acrylic polymer comprises a reaction product of an ethylenically unsaturated monomer composition comprising ethylenically unsaturated acid and the acid functional acrylic polymer has: (i) a weight average molecular weight of 500 to 6000;
(ii) a polydispersity value of no more than 2.5; and (iii) an acid value of at least 180, and wherein the composition has a resin solids content of greater than 40 percent by weight, based on the total weight of the composition.

16. The composition of claim 15, wherein the acid functional acrylic polymer has a Gardner-Holt viscosity of no more than Z2.

17. The composition of claim 15, wherein the acid functional acrylic polymer has a Tg of 40° C. to 50° C.

18. The composition of claim 15, wherein the acid functional acrylic polymer has: (i) a weight average molecular weight of 1000 to 3000; (ii) a polydispersity value of no more than 2.0; and (iii) an acid value of at least 200.

19. The composition of claim 15, wherein the acid functional acrylic polymer has (v) an APHA color of no more than 100.

20. The composition of claim 15, wherein the acid functional acrylic polymer is present in the composition in an amount of at least 90 percent by weight, based on the total weight of acid functional components in the composition.
